(19) United States
(12) Patent Application Publication
(10) Pub. No.: US 2002/0026425 A1
(43) Pub. Date: Feb. 28, 2002

(54) Method and apparatus for managing valuable documents

(76) Inventor: Christer Fahraeus, Lund (SE)

Correspondence Address: BIRCH STEWART KOLASCH & BIRCH, PO BOX 747, FALLS CHURCH, VA, 22040-0747, US

(21) Appl. No.: 09/813,116

(22) Filed: Mar. 21, 2001

Related U.S. Application Data
(60) Provisional application No. 60/210,653, filed on Jun. 9, 2000.

(30) Foreign Application Priority Data
Apr. 5, 2000 (SE) 0001252-6

(51) Int. Cl. G06F 17/60

(52) U.S. Cl. 705/64

(57) ABSTRACT

A method and apparatus for managing valuable documents may be carried out in a computer that is connected to a computer network. The method may include receiving an order via the computer network relating to a valuable document, and, in response to the order, creating the valuable document. The document creation may include associating the valuable document with a subset of a position-coding pattern. When used, the valuable document may be checked by a scanner to generate a control signal that includes at least one pair of coordinates. These coordinates may then be used to check the acceptability of the valuable document. A corresponding computer program, system, products, and arrangements are also described.

### CROSS-REFERENCE TO RELATED APPLICATIONS

This application claims priority benefits based on Swedish Patent Application No. 0001252-6, filed Apr. 5, 2000, and U.S. Provisional Application No. 60/210,653, filed Jun. 9, 2000, the technical disclosures of both of which are hereby incorporated herein by reference.

1. Field of the Invention

The present invention relates to methods and systems for managing documents, and more particularly to methods and systems for managing valuable documents.

2. Background of the Invention

Today, there are various types of valuable documents that, at defined locations, function as means of payment for products or services or as evidence of payment already made for products or services. Alternatively, a valuable document may function as a reservation for products or services.

An example of a valuable document is paper currency, such as a gift certificate, which can be used in one or more specified shops. An advantage of a gift certificate is that the person purchasing and giving the gift certificate may save time by not looking for a suitable present. The person giving a gift certificate may purchase it in a shop where the desired gift certificate is available. He or she may then send the gift certificate by post or give it in person to the recipient. The recipient of the gift certificate may then, by showing the gift certificate, purchase goods valued in the amount indicated on the gift certificate. The shopkeeper may only cursorily check the authenticity of the gift certificate, which risks that a falsified gift certificate is accepted as a means of payment. The gift certificate holder's right to use the gift certificate may be also seldom checked, which means that stolen or lost gift certificates may be used improperly.

Another example of a valuable document is a cinema ticket. Today it is possible to order cinema tickets on the Internet by visiting a cinema's home page, for example, and choosing a desired performance. In addition, one may also give one's telephone number, which may become the booking number. The tickets then have to be collected some time, often a full hour, before the performance starts.

### SUMMAR OF A FEW ASPECTS OF THE INVENTION

Methods and systems consistent with this invention manage valuable documents. Such methods and systems may receive an order from a computer network relating to a valuable document, and may create the valuable document in response to the order. The system may then associate the valuable document with a subset of a position-coding pattern.

Methods and systems consistent with this invention may be used to manage valuable documents. Such methods and systems may employ a plurality of coordinate areas in the computer and receive a control signal from the computer network, wherein the control signal includess at least one pair of coordinates that has been recorded by reading a position-coding pattern on a valuable document. They may also determine a coordinate area of the plurality of coordinate areas to which the pair of coordinates belongs, and check, with the aid of the determined coordinate area, whether the valuable document is acceptable.

The foregoing summarizes only a few aspects of the invention and is not intended to be reflective of the full scope of the invention as claimed. Additional features and advantages of the invention are set forth in the following description, may be apparent from the description, or may be learned by practicing the invention. Moreover, both the foregoing general description and the following detailed description are exemplary and explanatory and are intended to provide further explanation of the invention as claimed.

### DETAILED DESCRIPTION OF THE DRAWINGS

The invention will be described in greater detail below with reference to the accompanying drawings, in which

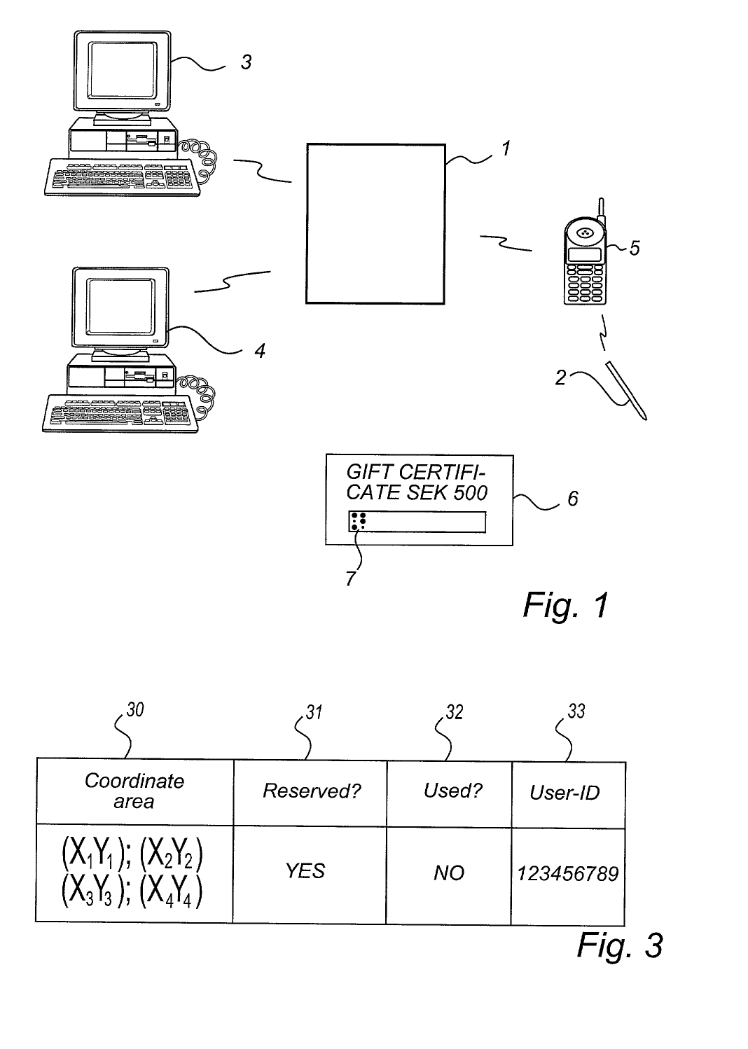

FIG. 1 shows a system, in accordance with the present invention, in which methods for management of a valuable document may be implemented;

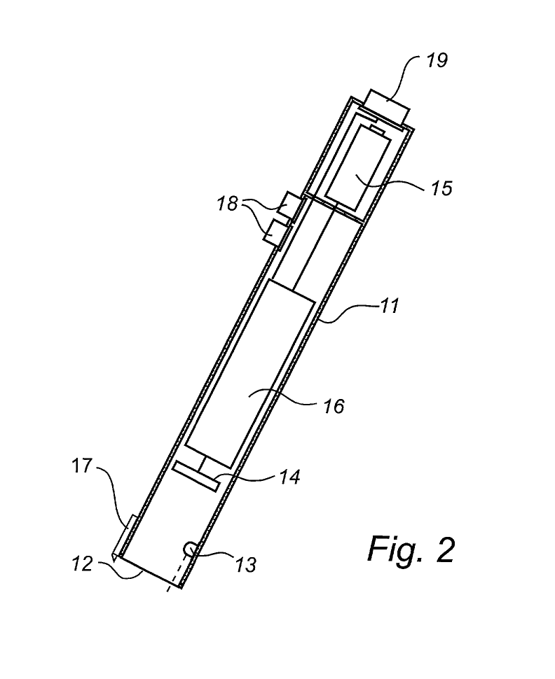

FIG. 2 shows an example of a user unit, in accordance with the present invention, which may be used in connection with a valuable document;

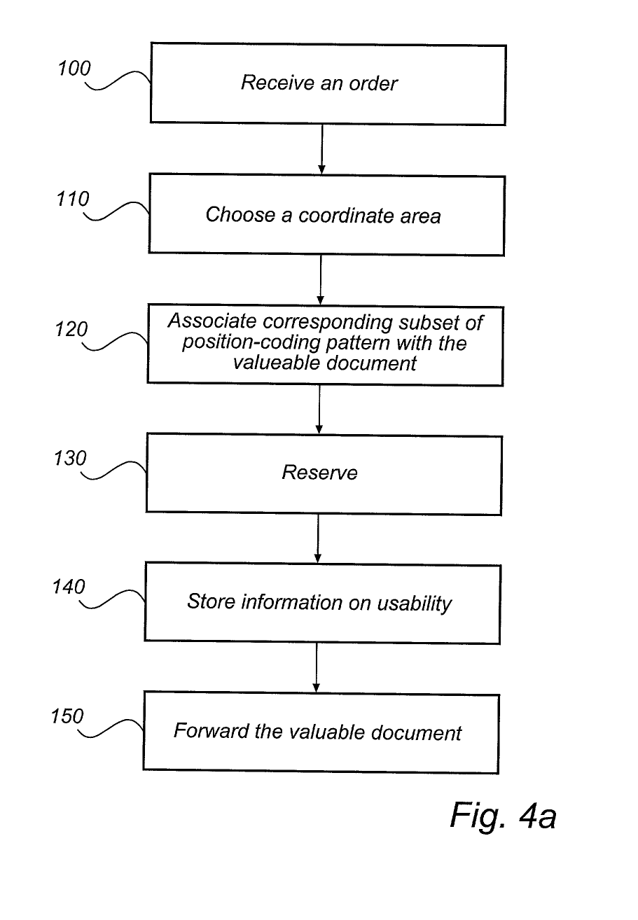

FIG. 3 shows an example of a storage structure for storing, among other things, control information in a server unit, in accordance with the present invention;

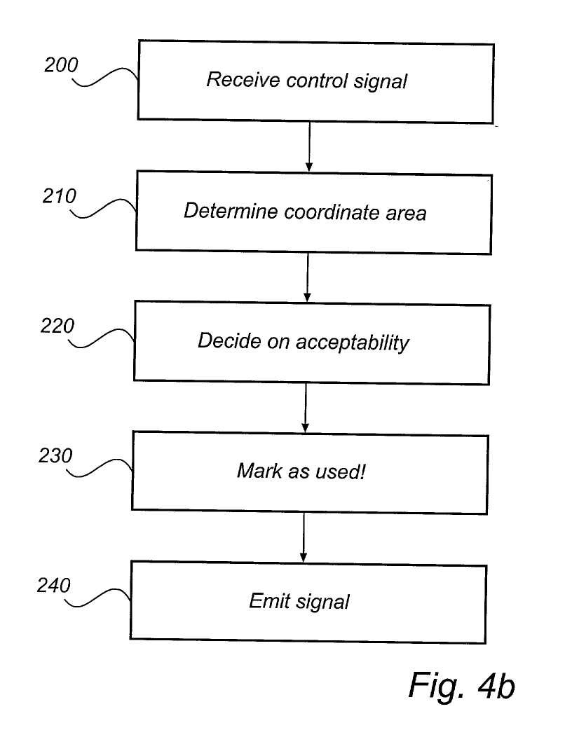

FIG. 4a shows a flow chart for ordering a valuable document according to one embodiment of the invention; and

FIG. 4b shows a flow chart for checking a valuable document according to another embodiment of the invention.

### DETAILED DESCRIPTION OF INVENTION

FIG. 1 shows an example of a system for the management of valuable documents. The system may include a server unit 1, a user unit 2, an ordering computer 3, a receiving computer 4, a network connection unit 5, and a valuable document 6. Valuable document 6 may have a subset of a position-coding pattern 7, described in further detail below.

Server unit 1 may include a computer that may be in a network of computers. Server unit 1 may comprise one or more processors, memory of different types (such as RAM or ROM), peripherals (such as printers and disk drives), and connections to other computers in the network. Server unit 1 may also include software for executing the functions described below. Server unit 1 may further store information, i.e. data, stored in its memory for executing these functions, and may be part of a global network or a local network, the latter used to process valuable documents within a company, for example.

Position-coding pattern 7 may comprise a number of types of symbols. It may have the feature that if any part of the pattern of a certain size is recorded, its position in the position-coding pattern, and thus on the valuable document, may be unambiguously determined. Position-coding pattern 7 may be invisible to the user.

An example of the position-coding pattern is disclosed in WO 00/73983, the technical disclosure of which is hereby incorporated herein by reference. In that disclosure, a large dot represents a “one” and a small dot represents a “zero.” Another example is disclosed in WO 01/16691, the technical disclosure of which is also incorporated herein. In this example, four different displacements of a dot in relation to a raster point codes four different values. The position-coding pattern may also be of the type disclosed in U.S. Pat. No. 5,852,434 (similarly incorporated herein by reference), in which each position may be coded by a specific symbol. As shown in these documents, each position may be coded by a plurality of symbols, and each symbol may contribute to the coding of a plurality of positions.

The position-coding pattern may code coordinates of points on at least one imaginary surface. The subset of the position-coding pattern may code coordinates within one coordinate area of the imaginary surface. The imaginary surface may comprise a plurality of coordinate areas. The imaginary surface may be a surface in a system of coordinates, which surface contains a large number of points that are arranged systematically in two dimensions with a given resolution. Each point may be defined with two coordinates. If there is more than one imaginary surface, more than two coordinates may define a point. A plurality of coordinate areas may be defined on the imaginary surface. The coordinate areas may be of different sizes and may have different shapes. The smallest possible coordinate area may comprise a single point on the surface. The whole surface may not necessarily be taken up by coordinate areas.

A plurality of different coordinate areas may be defined in the memory of server unit 1. A rectangular coordinate area, for example, may be described with pairs of coordinates representing the corners points of the coordinate area, or domain. These coordinate areas may be used for management of valuable documents, and each coordinate area may correspond to a subset of a position-coding pattern.

An advantage of position-coding pattern 7 and coordinate areas is that each valuable document may be unique. Position-coding pattern 7 may make it possible to define a position in a large imaginary surface. As described below, this may allow security to be increased because the pattern may permit security checks to be made on valuable document 6. For example, it may be more difficult to use a copied or falsified valuable document.

FIG. 2 shows an example of user unit 2 in the form of a digital pen that may be used for reading a subset of position-coding pattern 7 on valuable document 6. User unit 2 may include a casing 11 that may be shaped as a pen. On the short side of casing 11 there may be an opening 12. The short side may rest against or may be held at a short distance from the surface from which the position-coding pattern is read. The casing may include an optics part, an electronics part, and a power supply.

The optics part may comprise at least one light emitting diode 13 for illuminating the surface to be imaged, i.e. read. The optics part may also comprise a light-sensitive area sensor 14, such as a CCD or CMOS sensor, for example, for recording a two-dimensional image. User unit 2 may additionally contain a lens system. The power supply to user unit 2 may be provided by a battery 15 mounted in a separate compartment in casing 11. Alternatively, power may be provided via a cable.

The electronics part comprises a processor 16 which may process an image from sensor 14, identify symbols in the image, determine two coordinates for the symbols, and store these coordinates in its memory. Processor 16 may also generate a message, i.e. a control signal, that contains the coordinates and a unique user identity that may be stored in user unit 2, and may send this information to server unit 1 via a transceiver 19 and the network connection unit 5. Processor 16 may also analyze several recorded pairs of coordinates, convert these to a train of polygons constituting a description of how user unit 2, i.e. the digital pen, has been moved over the surface of valuable document 6, and generate a message which includes the train of polygons. Processor 16 may also send a message, i.e. a control signal, including the train of polygons to server unit 1.

User unit 2 may send the control signal to the server unit 1. For example, the control signal may be transmitted wirelessly to network connection unit 5, which in turn may transmit the control signal to server unit 1. Network connection unit 5 may be a mobile phone. It may alternatively be a computer or another suitable unit that may interface to a network, for example, the Internet or a local company network. Network connection unit 5 may alternatively be an integrated part of user unit 2.

Processor 16 may not necessarily send all the information to server unit 1. Processor 16 may analyze the recorded coordinates and only send information that is represented by coordinates within a specified coordinate area. For example, user unit 2 may belong to a particular shop and user unit 2 may recognize coordinates areas associate to the particular shop's valuable documents. If the recorded coordinates lie outside known coordinate areas, user unit 2 may indicate that valuable document 6 may not be used in the shop.

User unit 2 may comprise buttons 18 with which user unit 2 may be activated and controlled. Transceiver 19 may communicate wirelessly, i.e., by IR light or radio waves, with external units such as network connection unit 5. For example, the communication may be according to the Bluetooth technology, or some other technology for transferring information over distances. The information transfer by transceiver 19 does not need to be wireless, but instead may be by cable.

Information regarding valuable documents may be stored for each coordinate area. As shown in FIG. 1, valuable document 6 may be a gift certificate, which is provided with a subset of position-coding pattern 7. Thus, a subset of position-coding pattern on valuable document 6 codes coordinates within a coordinate area. One pair of coordinates may define a subset that corresponds to the coordinate area of valuable document 6. Because a plurality of coordinate areas may be defined in server 1, a plurality of unique valuable documents may be created.

FIG. 3 shows an example of a table for storing information about valuable documents. In a first column 30, the coordinate area on the imaginary surface is defined with the aid of the coordinates (x1,y1; x2,y2; x3,y3; x4,y4) for the corners of the coordinate area, which may be rectangular. A second column 31 may define whether the coordinate area is reserved or not. A third column 32 may indicate whether valuable document 6 associated with the to the coordinate area of first column 30 has been used or not.

A fourth column 33 may store one or more user unit identities in the form of serial numbers. Column 33 may be compared against the user unit that reads valuable document 6. This feature may increase security because it is possible to ensure that valuable document 6, and thus payment, is made from user units with serial numbers listed in column 33.

The table shown in FIG. 3 may include other columns. One column may be for an amount that corresponds to the value of valuable document 6. For example, valuable document 6 may be used more than once if its owner does not use the full amount the first time. Server unit 1 may then reduce the value of valuable document 6 stored in the table of FIG. 3. Valuable document 6 may operate, for example, similar to a cash card.

Another column may include a validity date indicating the last date for using valuable document 6. If this date is exceeded, third column 32 for the valuable document may be marked as used. Yet another column may be used for storing an address, i.e., the address of the recipient of valuable document 6 or the address of the person ordering valuable document 6. Still another column may be used for defining who receives payment for valuable document 6 when valuable document 6 is originally purchased. A column or some other memory area that is associated with the coordinate area in first column 30 may also log signatures that are written on a subset of the coordinate area defined in first column 30.

Of course, the table in FIG. 3 illustrates the principles involved. More complex structures and rules for security checking are possible. For example, other structures for storing the above-mentioned information and other items of information regarding valuable document 6 may be used.

An advantage of the information stored in the table of FIG. 3 is that server unit 1 may quickly check whether the coordinate area may be assigned a new order for a new valuable document. When a coordinate area is to be chosen for a new order, a coordinate area may be chosen from those that are not yet reserved.

General Example of Application

The invention relates to a method for management of valuable documents, which method may be carried out in a computer that is connected to a computer network, the method comprising the steps of receiving an order from the computer network relating to a valuable document, and, in response to the order, creating the valuable document, which comprises the step of associating the valuable document with a subset of a position-coding pattern.

FIG. 4a shows a flow chart for ordering a valuable document according to one embodiment of the invention. Assuming that a user wants to place an order for valuable document 6, the user may connect computer 3 to the server unit 1 and open an ordering form. An advantage of this ordering method is that it may permit ordering of valuable documents from a computer or mobile phone. The user may enter information for the order, such as how the payment for valuable document 6 is to be carried out. For example, the user may indicate an account number from which the payment is to be deducted. The account may be with the provider of valuable document 6, into which the user previously has made a deposit. The account may also be an ordinary bank account or the like. As another example, the user may indicate that he wants to be sent an invoice, which he would pay. As yet another example, the user may indicate that he wants a cash-on-delivery valuable document.

In one embodiment of the method, the step of creating valuable document 6 may comprise storing information to the effect that a coordinate area is reserved. For example, server unit 1 receives the order of valuable document 6 in step 100 of FIG. 4a. Server unit 1 may choose a vacant coordinate area, i.e., a coordinate area not already reserved for a valuable document (coordinate area selection step 110). In an association step 120, the coordinate area is associated with the ordered valuable document 6. The association of valuable document 6 with the coordinate area makes it possible to check that valuable document 6 is used only in the intended way.

Server unit 1 may store information that the coordinate area is reserved for ordered valuable document 6 (reservation step 130). Server unit 1 may also store other information, such as, for example, the valid usable date of valuable document 6, or other information which can be used to check the valuable document (storage step 140).

According to one embodiment, the step of creating valuable document 6 comprises the step of storing information about whether the coordinate area is usable. The coordinate area, and thus valuable document 6, may be marked usable directly at the time valuable document 6 is created. It can also be marked as non-usable directly at the time it is created and then marked as usable when a payment for the valuable document has been received.

According to one embodiment, the step of creating valuable document may comprise storing one or more identifiers that identify user units that are authorized to read the coordinate area. With the aid of identifiers, valuable document 6 may be associated with a specific user unit, and thus the security may be increased. Only a reading of valuable document 6 made by the indicated user unit, which may be the personal user unit of the gift certificate's owner, may be accepted. Alternatively, the indicated user unit may belong to a company or establishment where valuable document 6 may be used. In this way, attempts to use valuable document 6 at improper places may be prevented.

In one embodiment, the step of creating valuable document 6 may comprise the step of associating an address with the coordinate area. Associating an address with the coordinate area may have the advantage that it is possible to send a message to this address relating to valuable document 6. For example, this can be the address of the person purchasing valuable document 6, or the person who receives valuable document 6.

According to one embodiment, a message included in the control signal may be forwarded to an address associated with the coordinate area. An advantage of being able to send a message may be that the person using the valuable document can send a message to the purchaser of valuable document 6 stating that he or she has used valuable document 6. If valuable document 6 is a gift certificate, for example, the message can be a thank-you note.

In one embodiment, the step of creating valuable document 6 may comprise associating an amount with the coordinate area. The amount may, for example, be the amount of a gift certificate or the amount of a cash card. As a result of the amount being associated with the coordinate area, valuable document 6 may be used multiple times, the amount being counted down for each use.

Server unit 1 may forward valuable document 6 to the recipient specified in the order (forwarding step 150). Valuable document 6 may be sent electronically to receiving computer 4 or by normal post. If valuable document 6 is sent electronically, the recipient may print valuable document 6 on a printer. The recipient may be the same person as the person placing the order. By sending valuable document 6 in electronic format, acquiring valuable document 6 may be faster and easier.

The step of associating valuable document 6 with the coordinate area may involve the printing of valuable document 6 with the subset of position-coding pattern associated with the coordinate area. Server unit 1 may create one or more electronic files that make it possible for the recipient to print valuable document 6 with the coordinate area position-coding pattern.

An advantage of this is that the person placing the order for valuable document 6 may send it quickly to the recipient. For example, it can be sent by e-mail. Valuable document 6 may be sent as a pdf file. Valuable document 6 can then be printed out with the associated position-coding pattern. A further advantage of the possibility of sending the valuable document with the associated pattern electronically is that a company, for example, may itself print out the valuable document. Alternatively, valuable document 6 may be sent directly to a specified person via post.

The sending of valuable document 6 may be deferred until payment for valuable document 6 has been received. As an alternative, the marking of valuable document in the table shown in FIG. 3 as usable may be deferred until payment has been received.

According to another aspect of the invention, the invention may relate to a method for management of valuable documents, the method being carried out in a computer, which is connected to a computer network. A plurality of coordinate areas may be defined in the computer. The method may comprise the steps of receiving a control signal from the computer network which control signal comprises at least one pair of coordinates, which has been recorded by reading of a position-coding pattern on a valuable document, determining to which coordinate area of a plurality of coordinate areas the pair of coordinates belongs and checking, with the aid of the determined coordinate area, whether the valuable document is acceptable.

When valuable document 6 is used, user unit 2 may read the position-coding pattern on valuable document 6 by the placement of user unit 2 on the position-coding pattern so that a part of valuable document 6 is read. The user of valuable document 6 may also write his signature on the position-coding pattern with a pen attached to user unit 2. In this example, user unit 2 may record the coordinates of user unit's 2 position so that a description of the movement of user unit 2 may be obtained. The user may also write other information on the position-coding pattern.

The method can furthermore comprise the steps of identifying a signature in the received control signal and associating the signature with the coordinate area. An advantage of the position-coding pattern is that it can be used for recording handwriting, e.g., a signature. A person writing a signature on the valuable document increases security. The signature may be checked or verified against an identity paper. Alternatively, the signature can be stored and checked if a dispute regarding the use of a valuable document arises in the future.

For the purpose of checking valuable document 6, one embodiment may further comprise the steps of receiving a control signal comprising at least one pair of coordinates read from a valuable document, determining to which coordinate area of the plurality of coordinate areas the pair of coordinates belongs, and checking, on the basis of the determined coordinate area, whether the valuable document is acceptable. This method of checking is easy and flexible. FIG. 4b shows a flow chart for checking valuable document 6 according to one embodiment of the invention. User unit 2 creates, on the basis of the read the position-coding pattern, a control signal that is received by server unit 1 (receiving step 200). The control signal may consist of a message of predetermined format. It may comprise one or more pairs of coordinates.

When server unit 1 receives the control signal, it may determine to which coordinate area the pair of coordinates belongs (determination step 210). The acceptability of valuable document 6 is then decided (acceptability step 220). Server unit 1 may check whether valuable document 6 has already been used.

The method may further comprise the step of identifying in the control signal an identifier that indicates the identity of user unit 2 used for reading the position-coding pattern on valuable document 6. The method may further comprise the step of comparing the identifier in the control signal with the one or more identifiers associated with the determined coordinate area.

An advantage of this feature is that security may be increased because the valuable document may be accepted only if the position-coding pattern has been read with the proper user unit 2. To fool the system, it does consequently not suffice to have access to a specific valuable document, but access to the indicated user unit is required.

The identifier may be stored beforehand, e.g., when coordinate area 6 is reserved for a certain shop, or in connection with the order. Server unit 1 may also check the user unit's serial number, which may be received in the control signal. This feature increases security because a particular user unit may be required in order for valuable document 6 to be acceptable.

The control signal may further comprise information that identifies the establishment where the valuable document is used. Such information may be checked against information that is associated with the coordinate area, such as in the table of FIG. 3.

The control signal may also include an amount, which can be compared with the total amount associated with the coordinate area. The method can also comprise the step of identifying a payment amount in the received control signal and of comparing the payment amount with a total amount associated with the determined coordinate area. The amount in the control signal may be deducted from the total amount associated with the coordinate area. The remaining amount may then be stored as a new total amount, in the table of FIG. 3, for example. This step can be used for increasing security to prevent the owner of valuable document 6 from changing the stored amount.

In one embodiment, if valuable document 6 is accepted, server unit 1 may mark the valuable document as used so that it will not be able to be used again (marking step 230). Server unit 1 then may emit a signal that indicates the acceptability of valuable document 6, i.e., the result of the check. The signal may be sent to user unit 2 or to another predetermined unit or location.

The coordinate area that corresponds to used valuable document 6 can, directly or after a certain time, be marked as vacant, i.e., not reserved. The coordinate area may then be associated with a new valuable document, or another type of valuable document, which is valid for another product or service, possibly with another user unit, thus reducing the risk of a further use of an already used valuable document.

In connection with the use of valuable document 6, an amount paid by the person placing the order of valuable document 6 may be transferred to the establishment where valuable document 6 is used. The transfer may also be made earlier, e.g., in connection with the payment.

Generally, valuable document 6 may be used as means of payment in a number of different places. For example, valuable document 6 may be used in a chain of shops, in a restaurant, in a cinema, or in another type of operation where payment can be made with valuable documents.

Valuable document 6 may be used one or more times. If the valuable document may be used several times, server unit 1 may indicate each instance valuable document 6 was used when a control signal is received. When valuable document 6 has been used the permitted number of times, the coordinate area, and thus the valuable document may be marked as being used. When valuable document 6 has been used, the coordinate area may be marked as vacant and it may be reserved for a new valuable document order. Again, this may be done immediately or after a certain period of time.

Each shop may have its own server unit 1 with information concerning its own valuable documents. There may also be a central server unit that has a certain number of coordinate areas reserved for each of the shops and has information concerning which coordinate areas belong to which shops. The shops may purchase a certain number of coordinate areas. To increase the flexibility of the system, any user unit may be used without having to install special software in the user unit or server unit for each shop. The information concerning payment may therefore be sent via the central server unit which, with the aid of the read coordinates in the control signal, may decide to which coordinate area the read coordinates belong, and thus also decide to which shop the valuable document belongs. The information may then be sent on to the shop's server unit 1 in which more detailed control information is stored. Alternatively, the information may be processed directly in the central server.

An advantage of the above described system and method is that the person who receives valuable document 6, e.g., as a means of payment in a shop, can get an immediate signal as to its acceptability or validity. The signal can be, for example, not only an indication as to whether the valuable document is acceptable or not, but may include further information, including for example, the reason why a valuable document cannot be accepted. In addition, the signal can include information about, for instance, the value of valuable document 6 or the amount remaining after a payment.

This method and system described above for checking whether valuable document 6 is acceptable or not may be simple and very flexible because different criteria for the acceptability may be associated with the coordinate area. Furthermore, only a small amount of information may have to be recorded and transferred in order to make possible the check. Moreover, the check can be made in real time.

Further, the method and system for checking may be used for valuable documents created with the above-described method or created in other ways. For instance, valuable documents may be printed in an ordinary printing works or purchased directly in a shop.

According to another aspect, the invention may relate to a computer program product comprising program code which when loaded into a computer is arranged to execute the above-described method for providing a valuable document. According to yet another aspect, the invention may also relate to a computer program product comprising program code which when loaded into a computer is arranged to execute the above-described method for checking a valuable document. Both the method used for providing a valuable document and the method used for checking a valuable document may be implemented with the aid of computer software.

Gift Certificate Application

A person, remembering it is his brother's birthday, desires to order a gift certificate 6 and give it to the brother. The person ordering the gift certificate has a computer with Internet access and he visits the home page of the company “Shop and Buy.” On this home page, he may order gift certificates that can be used in a large number of shops connected to the “Shop and Buy” gift certificate management server. The person ordering the gift certificate places an order for it. He enters, for example, the total value of the gift certificate, which in this example is $100, his brother's e-mail address, and his own credit card number from which the cost of the gift certificate is to be deducted. The order is sent off to the “Shop and Buy” server. The server chooses a vacant coordinate area, i.e., a coordinate area that is not reserved for any other valuable document. The chosen coordinate area is marked as reserved and the sum on the gift certificate is associated with the coordinate area in a table. The gift certificate is associated with the chosen coordinate area's subset of a position-coding pattern. The gift certificate is then sent to the brother's e-mail address. The gift certificate may be stored in a portable document file (pdf) and sent via the computer network. The brother receives the gift certificate on his computer and prints it out. Money is drawn from the specified credit card number and the gift certificate is marked as usable.

When the gift certificate recipient wishes to pay for something with the gift certificate, he may hand it to cashier who places a digital pen belonging to the shop against the gift certificate. The position-coding pattern of the gift certificate is read, converted to coordinates, and sent with the pen's serial number to the “Shop and Buy” server. The “Shop and Buy” server searches for the coordinate area that is associated with the received coordinates. It then checks if the gift certificate is valid. It may do this, for example, by checking that the gift certificate has not already been used or that the last date of use has not expired. It also checks to ensure that the pen's serial number corresponds to the serial number of pens that are authorized to record the gift certificate. After checking, the server may mark the gift certificate as used, so that it cannot be used again. Immediately after a gift certificate has been marked as used, the coordinate area may be marked as not reserved. Alternatively, the coordinate area may be marked as not reserved after a certain period of time.

If the gift certificate is not acceptable, a signal with information concerning this may be sent to the digital pen, i.e., the cashier. The information may include the reason for the gift certificate being invalid. If the gift certificate is valid, a clearance signal may be sent to the cashier. The signal to the pen may also include information concerning the value of the gift certificate. The information concerning the validity may be displayed on a computer with which the pen communicates.

If the user is not buying something for the full value of the gift certificate, the purchase sum may be sent together with the coordinates to the “Shop and Buy” server. The server may deduct the received amount, and the gift certificate can be used again.

Cinema tickets, for example, may be booked in a similar way to the management of gift certificates.

Restaurant Vouchers Application

A restaurant may, for advertising purposes, issue vouchers for different meals. Such vouchers may be free of charge, to attract visitors to an Internet site, or may require payment. The restaurant may also sell a book of vouchers that can be used for payment in the restaurant. In other words, the vouchers are valuable documents in this example. To increase security, these vouchers are each provided with a subset of a position-coding pattern, i.e., a coordinate area, so that they can be recognized in a simple manner. When a restaurant customer pays with the voucher, the cashier places a digital pen, i.e., a user unit, against the voucher and part of the position-coding pattern is recorded and converted to coordinates. The coordinates are sent to a server unit, which checks whether the voucher is valid. In the server unit there are a number of coordinate areas. The coordinate area to which the coordinates belong is found and the details of the voucher are checked. The coordinate area is then marked as used and the voucher is rendered unusable.

Traveler's Checks Application

A traveler does not want to carry too much cash because of the risk of loss and theft. The traveller may order traveler's checks for a desired amount via a computer with Internet access. In this example, the traveler's check is a valuable document. The traveler may give his credit card number which, together with other order information, is sent to a server unit. The traveller may specify the dates he wishes the traveller's checks to be valid, e.g., the days the traveler is traveling. This feature reduces the risk that the traveler's checks are used by an unauthorized person. The amount for which the traveller's checks are worth is drawn from the credit card.

The traveler's checks are associated with certain coordinate areas in the server unit. The checks are provided with the subsets of a position-coding pattern that are associated with these coordinate areas. The traveler's checks are sent electronically to the traveller, who may print them out on a printer. When the traveller pays with his traveller's checks, someone at the point of purchase touches the traveler's check with a digital pen and records coordinates. The recording may be supplemented by the traveller's signature. The digital pen forwards the recorded information together with the pen's serial number to server unit in which the details of the traveller's check are stored. The server checks the coordinate area to which the received coordinates belong. The server determines whether the traveler's check is valid. The pen's serial number informs the server of where the purchase took place. The coordinate area, and thus the traveller's check, are then marked as used in the server unit, and the used traveller's check is then invalid.

Messages Application

It may be possible to write a message on a valuable document, which message may be forwarded to an address stored in the server unit. The message may be written by a user with a digital pen, i.e., user unit 2 on the position-coding pattern.

If the valuable document is a gift certificate, for example, the person ordering the gift certificate may give his mobile phone number when ordering. The server unit receives the order, chooses a vacant coordinate area and stores the mobile number together with certain other order details in the server unit. The Gift certificate is sent to the person who has been specified in the order.

The address may be stored at the time of ordering of the valuable document. In the case where the valuable document is a gift certificate, the address can be the address of the person who purchased the gift certificate. An address can, for example, be a mobile phone number or an e-mail address to which a text message can be sent. The address can also be a normal postal address to which a message can be sent by normal post after it has been printed out.

When the person who has received the gift certificate uses it, he can write a message on the gift certificate using a digital pen. The message may be recorded by the digital pen and sent to the server unit. The server unit receives the signal and searches for the coordinate area associated with the gift certificate. The server unit checks the acceptability of the gift certificate. If it is acceptable, the message may be sent on to the mobile number that was given when the gift certificate was purchased. In this way, the person who ordered the gift certificate may learn that the gift certificate has been used, and the person who received the gift certificate may thank the person who gave it.

Concurrently filed with the application for this patent are applications entitled Systems and Methods for Information Storage based on Swedish Application No. 0000947-2, filed Mar. 21, 2000, and U.S. Provisional Application No. 60/207,839, filed May 30, 2000; Secured Access Using a Coordinate System based on Swedish Application No. 0000942-3, filed Mar. 21, 2000, and U.S. Provisional Application No. 60/207,850 filed on May 30, 2000; System and Method for Printing by Using a Position Coding Pattern based on Swedish Application No. 0001245-0, filed on Apr. 5, 2000, and U.S. Provisional Application No. 60/210,651, filed on Jun. 9, 2000; Apparatus and Methods Relating to Inage Coding based on Swedish Application No. 0000950-6, filed on Mar. 21, 2000, and U.S. Provisional Application No. 60/207,838, filed on May 30, 2000; Apparatus and Methods for Determining Spatial Orientation based on Swedish Application No. 0000951-4, filed on Mar. 21, 2000, and U.S. Provisional Application No. 60/207,844, filed on May 30, 2000; System and Method for Determining Positional Information based on Swedish Application No. 0000949-8, filed Mar. 21, 2000, and U.S. Provisional Application No. 60/207,885, filed on May 30, 2000; Method and System for Transferring and Displaying Graphical Objects based on Swedish Application No. 0000941-5, filed Mar. 21, 2000, and U.S. Provisional Application No. 60/208,165, filed May 31, 2000; Online Graphical Message Service based on Swedish Application No. 0000944-9, filed Mar. 21, 2000, and U.S. Provisional Application No. 60/207,881, filed May 30, 2000; Method and System for Digitizing Freehand Graphics With User-Selected Properties based on Swedish Application No. 0000945-6, filed Mar. 21, 2000, U.S. Provisional Application No. 60/207,882, filed May 30, 2000; Data Form Having a Position-Coding Pattern Detectable by an Optical Sensor based on Swedish Application No. 0001236 -9, filed Apr. 5, 2000, and U.S. Provisional Application No. 60/208,167, filed May 31, 2000; Method and Apparatus for Managing Valuable Documents based on Swedish Application No. 0001252-6, filed Apr. 5, 2000, and U.S. Provisional Application No. 60/210,653 filed Jun. 9, 2000; Method and Apparatus for Information Management based on Swedish Application No. 0001253-4 filed Apr. 5, 2000, and U.S. Provisional Application No. 60/210,652, filed Jun. 9, 2000; Device and Method for Communication based on Swedish Application No. 0000940-7, filed Mar. 21, 2000, and U.S. Provisional Application No. 60/208,166, filed May 31, 2000; Information-Related Devices and Methods based on Swedish Application No. 0001235-1, filed Apr. 5, 2000, and U.S. Provisional Application No. 60/210,647, filed Jun. 9, 2000; Processing of Documents based on Swedish Application No. 0000954-8, filed Mar. 21, 2000, and U.S. Provisional Application No. 60/207,849, filed May 30, 2000; Secure Signature Checking System based on Swedish Application No. 0000943-1, filed Mar. 21, 2000, and U.S. Provisional Application No. 60/207,880, filed May 30, 2000; Identification of Virtual Raster Pattern, based on Swedish Application No. 0001235-1, filed Apr. 5, 2000, and U.S. Provisional Application No. 60/210,647, filed Jun. 9, 2000, and Swedish Application No. 0004132-7, filed Nov. 10, 2000, and U.S. Provisional Application No. ______, filed Jan. 12, 2001; and a new U.S. Provisional Application entitled Communications Services Methods and Systems.

The technical disclosures of each of the above-listed U.S. applications, U.S. provisional applications, and Swedish applications are hereby incorporated herein by reference. As used herein, the incorporation of a “technical disclosure” excludes incorporation of information characterizing the related art, or characterizing advantages or objects of this invention over the related art.

In the foregoing Description of Preferred Embodiments, various features of the invention are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Preferred Embodiments, with each claim standing on its own as a separate preferred embodiment of the invention.

What is claimed is:

1. A method for managing valuable documents, the method being carried out using a computer connected to a computer network, the method comprising:
receiving an order via the computer network relating to a valuable document; and
creating the valuable document in response to the order by associating with the valuable document a subset of a position-coding pattern.

2. The method according to claim 1, wherein the position-coding pattern codes coordinates of points on an imaginary surface and wherein the subset of the position-coding pattern codes coordinates within one coordinate area of a plurality of coordinate areas that are defined in the computer.

3. The method according to claim 2, wherein creating the valuable document includes storing information to reserve the one coordinate area.

4. The method according to claim 2, wherein creating the valuable document includes storing information to render usable the one coordinate area.

5. The method according to claim 2, wherein creating the valuable document includes associating an address with the one coordinate area.

6. The method according to claim 2, wherein creating the valuable document includes associating a monetary amount with the one coordinate area.

7. The method according to claim 2, wherein creating the valuable document includes associating an identifier, which identifies a user unit that is authorized to read the subset of the position-coding pattern, with the one coordinate area.

8. The method according to claim 2, wherein creating the valuable document includes storing an indication of a payment recipient, to whom the payment for the valuable document is to be transferred.

9. The method according to claim 2, further including forwarding the valuable document.

10. The method according to claim 9, wherein the document is forwarded electronically via the computer network.

11. The method according to claim 2, wherein the valuable document is associated with a unique subset of the position-coding pattern.

12. The method according to claim 2, further comprising:
receiving a control signal comprising at least one pair of coordinates recorded from the valuable document;
determining a coordinate area of a plurality of coordinates to which the pair of coordinates is a subset; and
checking, on the basis of the determined coordinate area, whether the valuable document is acceptable.

13. The method according to claim 12, further comprising marking the valuable document as used.

14. The method according to claim 12, further comprising forwarding a message included in the control signal to an address associated with the determined coordinate area.

15. A method for managing valuable documents, the method being carried out using a computer connected to a computer network, wherein a plurality of coordinate areas is defined in the computer, the method comprising:
receiving a control signal from the computer network, wherein the control signal comprises at least one pair of coordinates that has been recorded by reading a position-coding pattern on a valuable document;
determining a coordinate area of the plurality of coordinate areas to which the pair of coordinates belongs; and
checking, with the aid of the determined coordinate area, whether the valuable document is acceptable.

16. The method according to claim 15, further comprising transmitting a signal to the computer network to indicate an acceptability of the valuable document.

17. The method according to claim 15, further comprising marking the determined coordinate area as used.

18. The method according to claim 15, further comprising identifying a signature in the received control signal and associating the signature with the determined coordinate area.

19. The method according to claim 15, further comprising identifying, in the control signal, a payment amount, and comparing the payment amount with a total amount associated with the determined coordinate area.

20. The method according to claim 15, further comprising identifying, in the control signal, an identifier which indicates the identity of a user unit used for reading the position coding pattern on the valuable document, wherein checking comprises comparing the identifier in the control signal with an identifier associated with the determined coordinate area.

21. An apparatus managing valuable documents in a computer connected to a computer network, the apparatus comprising:
means for receiving an order via the computer network relating to a valuable document; and
means for creating the valuable document in response to the order and for associating the valuable document with a subset of a position-coding pattern.

22. The apparatus according to claim 21, further comprising means for carrying out the order for a valuable document.

23. An apparatus for managing valuable documents using a computer connected to a computer network, wherein a plurality of coordinate areas are defined in the computer, the apparatus comprising:
means for receiving a control signal from the computer network, which control signal includes at least one pair of coordinates, which have been recorded by reading of a position-coding pattern on a valuable document;
means for determining to which coordinate area of the plurality of coordinate areas the pair of coordinates belongs; and
means for checking, on the basis of the determined coordinate area, if the valuable document is acceptable.

24. A computer with a memory having a data structure, wherein the data structure comprises:
a first field for storing two-dimensional coordinates that define a coordinate area that is a subset of a position-coding pattern surface;
a second field for storing data indicating whether a document associated with the coordinate area is reserved; and
a third field for storing data indicating whether the document has been used.

25. The computer of claim 24, wherein the data structure further comprises a fourth field for storing data indicating a user unit authorized to determine a position in the coordinate area on the position-coding surface.

26. The computer of claim 24, wherein the data structure further comprises a fourth field for storing data indicating a value associated with the document.

27. The computer of claim 24, wherein the data structure further comprises a fourth field for storing data indicating a validity date of the document.

28. The computer of claim 24, wherein the data structure further comprises a fourth field for storing data indicating an address.

29. The computer of claim 24, wherein the data structure further comprises a fourth field for storing data indicating a signature.

30. The computer of claim 24, wherein the data structure further comprises a fourth field for storing data indicating a message.

31. The computer of claim 26, wherein the data structure further comprises a fifth field for storing data indicating a validity date of the document.

32. The computer of claim 31, wherein the data structure further comprises a sixth field for storing data indicating a signature.

33. A computer-readable medium containing instructions for controlling a computer system to perform a method of operating a processor, the method comprising:
receiving an order from the computer network relating to a valuable document; and
creating the valuable document in response to the order by associating the valuable document with a subset of a position-coding pattern.

34. The computer-readable medium according to claim 33, wherein the position-coding pattern codes coordinates of points on an imaginary surface and wherein the subset of the position-coding pattern codes coordinates within one coordinate area of a plurality of coordinate areas that are defined in the computer.

35. The computer-readable medium according to claim 34, wherein creating the valuable document comprises storing information to reserve the one coordinate area.

36. The computer-readable medium according to claim 34, wherein creating the valuable document comprises storing information to render usable at least one coordinate area.

37. The computer-readable medium according to claim 34, wherein creating the valuable document includes associating an address with the at least one coordinate area.

38. The computer-readable medium according to claim 34, wherein creating the valuable document includes associating a monetary amount with the at least one coordinate area.

39. The computer-readable medium according to claim 34, wherein creating the valuable document comprises associating an identifier, which identifies a user unit that is authorized to read the subset of the position-coding pattern, with the one coordinate area.

40. The computer-readable medium according to claim 34, wherein creating the valuable document comprises storing an indication of a payment recipient to whom the payment for the valuable document is to be transferred.

41. The computer-readable medium according to claim 34, wherein the method further comprises forwarding the valuable document.

42. The computer-readable medium according to claim 41, wherein the document is forwarded electronically via the computer network.

43. The computer-readable medium according to claim 34, wherein the valuable document is associated with a unique subset of the position-coding pattern.

44. The computer-readable medium according to claim 34, wherein the method further comprises:
receiving a control signal comprising at least one pair of coordinates recorded from the valuable document;
determining a coordinate area of a plurality of coordinates to which the pair of coordinates belongs; and
checking, on the basis of the determined coordinate area, whether the valuable document is acceptable.

45. The computer-readable medium according to claim 44, wherein the method further comprises marking the valuable document as used.

46. The computer-readable medium according to claim 44, wherein the method further comprises forwarding a message included in the control signal to an address associated with the determined coordinate area.

47. A computer-readable medium containing instructions for controlling a computer system to perform a method of operating a processor for management of valuable documents, wherein the method is carried out in the computer connected to a computer network, wherein a plurality of coordinate areas is defined in the computer, the method comprising:
receiving a control signal from the computer network, wherein the control signal includes at least one pair of coordinates that has been recorded by reading a position-coding pattern on a valuable document;
determining a coordinate area of the plurality of coordinate areas to which the pair of coordinates belongs; and
checking, with the aid of the determined coordinate area, whether the valuable document is acceptable.

48. The computer-readable medium of claim 47, wherein the method further comprises transmitting a signal to the computer network to indicate the acceptability of the valuable document.

49. The computer-readable medium of claim 47, wherein the method further comprises marking the determined coordinate area as used.

50. The computer-readable medium according to claim 47, wherein the method further comprises identifying a signature in the received control signal and associating the signature with the determined coordinate area.

51. The computer-readable medium according to claim 47, wherein the method further comprises identifying, in the control signal a payment amount, and comparing the payment amount with a total amount associated with the determined coordinate area.

52. The computer-readable medium according to claim 47, further comprising identifying in the control signal, an identifier which indicates an identity of a user unit used for reading the position coding pattern on the valuable document, wherein the checking includes comparing the identifier in the control signal with an identifier associated with the determined coordinate area.

53. A method for authenticating paper currency, the method comprising:
printing on the currency a subset of a position coding pattern;
associating in a database the subset of the position coding pattern with an indicator reflective of a currency characteristic;
imaging the subset of the position coding pattern on the currency to generate a signal reflective thereof;
transmitting the signal to the database; and
comparing information reflected by the signal with information in the database to thereby confirm the currency characteristic.
